(19) United States
(12) Patent Application Publication
(10) Pub. No.: US 2024/0277147 A1
(43) Pub. Date: Aug. 22, 2024

(54) PERSONAL HEATER FOR A SALON CHAIR

(71) Applicant: Amy Barley, Clarkston, WA (US)

(72) Inventor: Amy Barley, Clarkston, WA (US)

(21) Appl. No.: 18/112,577

(22) Filed: Feb. 22, 2023

(51) Int. Cl. A47C 1/11; A47C 7/74

(52) U.S. Cl. CPC A47C 1/11; A47C 7/748

(57) ABSTRACT

A personal heating assembly for heating a user while sitting in a salon chair includes a salon chair comprising a seat. The seat has a top surface which is oriented horizontally. The seat is configured for supporting a user on the top surface. A heater is coupled to the salon chair. The heater is positioned above and laterally to the seat and is configured to heat air and urge heated air above the seat in order to heat the user when then user sits on the seat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to personal heaters and more particularly pertains to a new personal heater for heating a user while sitting in a salon chair.

### (2) Description of Related Art including information disclosed under 37 CFR 1.97 and 1.98.

The prior art relates to personal heaters, including a chair which heats itself and chairs which have a backrest that contains a heater that blows heated air into the back of a user.

### BRIEF SUMMARY OF THE INVENTION

An embodiment of the disclosure meets the needs presented above by generally comprising a salon chair comprising a seat. The seat has a top surface which is oriented horizontally. The seat is configured for supporting a user on the top surface. A heater is coupled to the salon chair. The heater is positioned above and laterally to the seat and is configured to heat air and urge heated air above the seat in order to heat the user when then user sits on the seat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a heater of a personal heating assembly according to an embodiment of the disclosure.

FIG. 2 is a front view of a heater of an embodiment of the disclosure.

FIG. 3 is a side view of a heater of an embodiment of the disclosure.

FIG. 4 is a bottom view of a heater of an embodiment of the disclosure.

FIG. 5 is a perspective in-use view of an embodiment of the disclosure.

FIG. 6 is a front in-use view of an embodiment of the disclosure.

FIG. 7 is a block diagram of a heater of an embodiment of the disclosure.

### DETAILED DESCRIPTION OF THE INVENTION

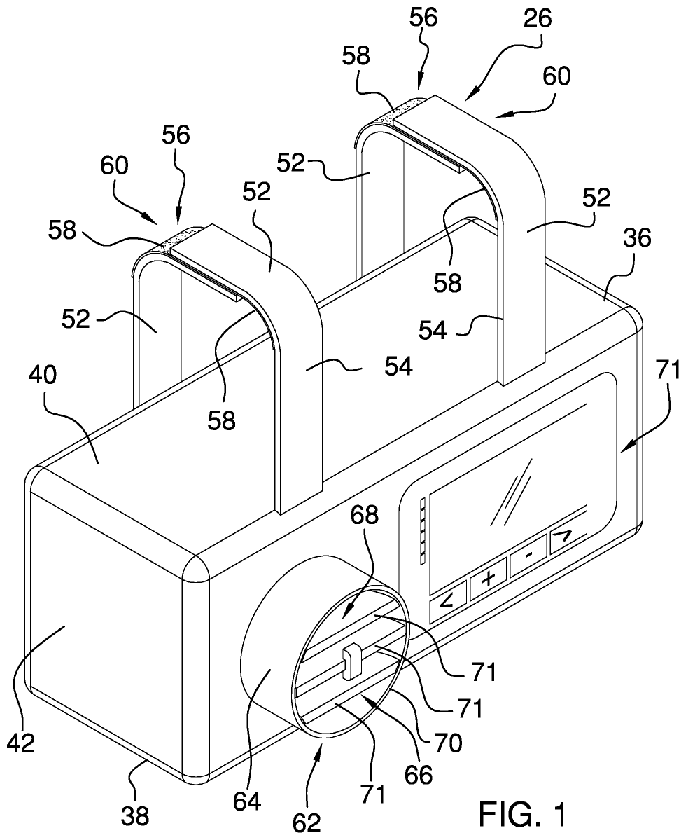

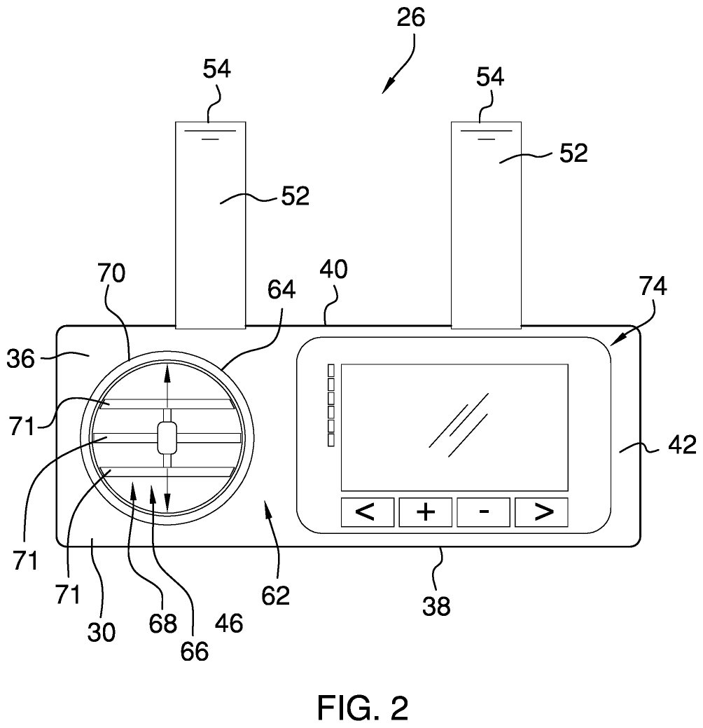

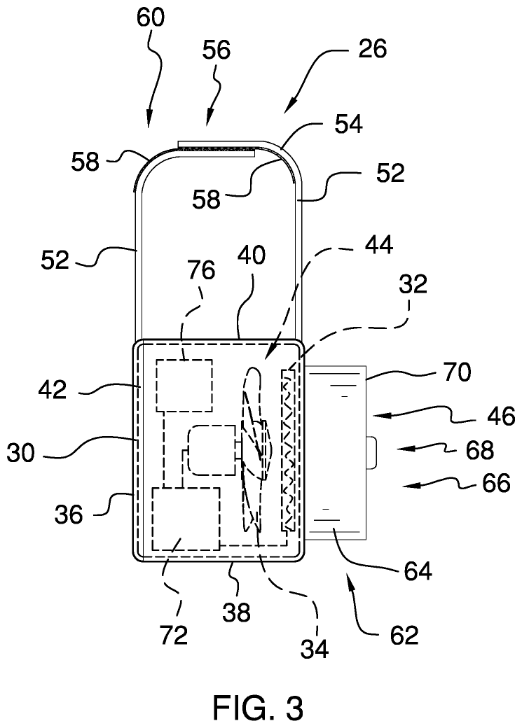

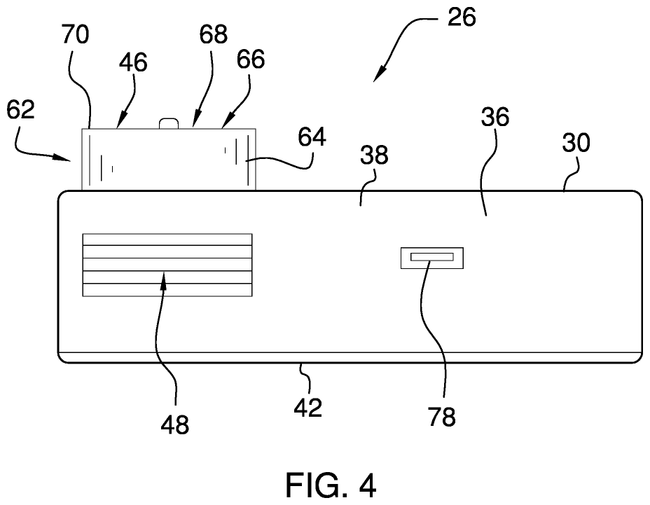

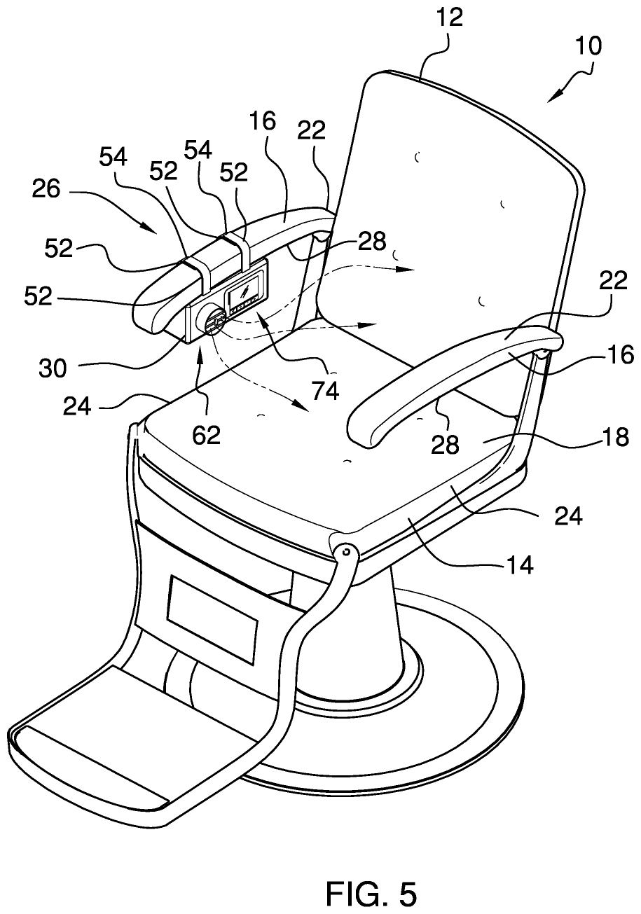

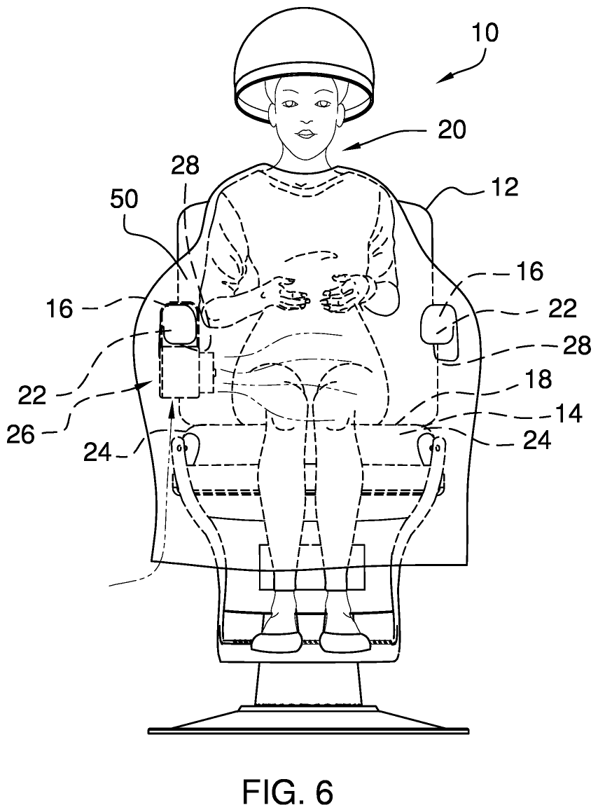

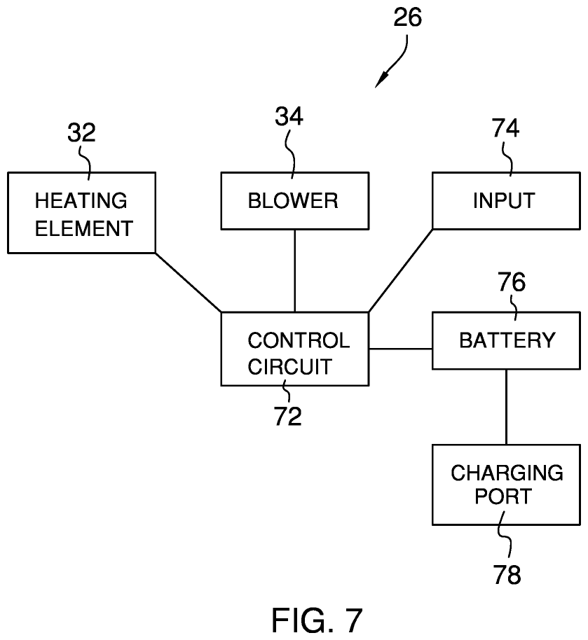

With reference now to the drawings, and in particular to FIGS. 1 through 7 thereof, a new personal heater embodying the principles and concepts of an embodiment of the disclosure and generally designated by the reference numeral 10 will be described.

As best illustrated in FIGS. 1 through 7, the personal heating assembly 10 generally comprises a salon chair 12 comprising a seat 14 and an armrest 16. The seat 14 has a top surface 18 which is oriented horizontally, and the seat 14 is configured for supporting a user 20 on the top surface 18. The armrest 16 is coupled to the seat 14 and has an arm support portion 22 which is spaced above a lateral side 24 of the seat 14. A heater 26 is coupled to the salon chair 12 which is configured for heating a user 20 sitting on the seat 14. The heater 26 is coupled to the arm support portion 22 of the armrest 16 and is positioned on an underside 28 of the arm support portion 22.

The heater 26 comprises a housing 30, a heating element 32, and a blower 34. The housing 30 comprises an outer wall 36 that has a bottom member 38, a top member 40, and a perimeter member 42. The perimeter member 42 extends between the top member 40 and the bottom member 38. The housing 30 also has an interior space 44 bounded by the outer wall 36. An outlet vent 46 extends through the perimeter wall into the interior space 44. An inlet vent 48 extends through the outer wall 36 into the interior space 44 and may be positioned on the bottom member 38 so that air is not blocked from entering the interior space 44 due to the arm support portion 22 or a hairdressing cape 50 worn by the user 20. The heating element 32 and the blower 34 are each positioned within the interior space 44 and coupled to the housing 30. The heating element 32 may comprise an electrical resistance heater, a heat pump, or the like for generating heat. The blower 34 may comprise a fan, air pump, or the like for selectively urging air to flow. The blower 34 is positioned such that it urges air to flow into the interior space 44 through the inlet vent 48, across the heating element 32 to be heated by the heating element 32, and through the outlet vent 46. The outlet vent 46 is positioned such that the air moved by the blower 34 is directed above the seat 14 after flowing through the outlet vent 46. The air thus heats a user 20 sitting on the seat 14.

The heater 26 may also be detachably coupled from the salon chair 12 via a releasable fastener such as a threaded fastener, spring-biased fastener, a hook, or the like. In one embodiment, the heater 26 further comprises a pair of straps 52 which are each coupled to the housing 30. Each of the pair of straps 52 extend upwardly from the housing 30 and wrap around the arm support portion 22 of the armrest 16 such that the pair of straps 52 form a loop 54 around the arm support portion 22. Each of a pair of mating members 58 of a connector 56 is coupled to a respective one of the pair of straps 52 such that the pair of mating members 58 releasably engage each other. The connector 56 may be a hook-and-loop fastener 60, a buckle, a snap fastener, or the like.

A louver 62 is coupled to and extends outwardly from the housing 30 for directing the air exiting the outlet vent 46 in one of a range of angles to the housing 30. The louver 62 comprises a circumferential wall 64 which surrounds the outlet vent 46. The circumferential wall 64 defines a duct 66 which is in fluid communication with the outlet vent 46. The circumferential wall 64 has an opening 68 at a distal end 70 of the circumferential wall 64 relative to the housing 30. A plurality of vanes 71 is movably coupled to the circumferential wall 64 and is positioned within the duct 66. Each of the plurality of vanes 71 is orientable in one of a range of angles relative to the housing 30 so the air moving out of the outlet is directed in one of a range of angles to the housing 30 as it leaves through the opening 68.

A control circuit 72 is coupled to the housing 30 and positioned within the interior space 44. The control circuit 72 is electrically coupled to the heating element 32 and the blower 34 so that the control circuit 72 selectively activates each of the heating element 32 and the blower 34. An input 74 is coupled to the outer wall 36 of the housing 30. The input 74 is electrically coupled to the control circuit 72 and is actuatable to activate each of the heating element 32 and the blower 34. The input 74 may comprise depressible buttons, knobs, switches, a touchscreen, or the like for operating the heating element 32 and the blower 34. The input 74 may also include a display screen which displays information related to the operation of the heater 26, such as whether each of the heating element 32 and the blower 34 is activated, different heating levels, and different fan speeds. The display screen may also be integral with the touchscreen. A battery 76 is positioned within the interior space 44 and is electrically coupled to the control circuit 72 to electrically power the control circuit 72, the heating element 32, and the blower 34. A charging port 78 electrically coupled to the battery 76 may be positioned on the outer wall 36 of the housing 30 for charging the battery 76. Alternatively, the control circuit 72 may be electrically powered by an alternating current electrical power supply, an external battery, or the like.

In use, the user 20 sits on the seat 14 of the salon chair 12 with the hairdressing cape 50 draped over the armrest 16. The heating element 32 and the blower 34 are each activated via the input 74 to blow heated air onto the user 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal heating assembly comprising:
a salon chair comprising a seat, the seat having a top surface being oriented horizontally and being configured for supporting a user on the top surface; and
a heater being coupled to the salon chair, the heater being positioned above and laterally to the seat, the heater being configured to heat air and urge heated air above the seat.

2. The assembly of claim 1, further comprising the heater comprising:
a housing comprising an outer wall, the housing having an interior space bounded by the outer wall, the housing having an outlet vent extending through the outer wall into the interior space, the housing having an inlet vent extending through the outer wall into the interior space;
a heating element being coupled to the housing and being positioned within the interior space, the heating element selectively generating heat; and
a blower being coupled to the housing and being positioned within the interior space, the blower selectively urging air to flow into the interior space through the inlet vent, across the heating element, and through the outlet vent, wherein the outlet vent is positioned such that the air is directed above the seat after flowing through the outlet vent.

3. The assembly of claim 1, further comprising:
the salon chair further comprising an armrest being coupled to the seat, the armrest having an arm support portion being spaced above a lateral side of the seat; and
the heater being coupled to the arm support portion of the armrest, the heater being positioned on an underside of the arm support portion.

4. The assembly of claim 2, further comprising the outer wall of the heater comprising a bottom member, a top member, and a perimeter member, the perimeter member extending between the bottom member and the top member, the outlet vent extending through the perimeter member, the inlet vent extending through the bottom member.

5. The assembly of claim 1, further comprising the heater being detachable from the salon chair.

6. The assembly of claim 3, further comprising the heater further comprising:
a pair of straps, each of said pair of straps being coupled to the housing, each of the pair of straps extending upwardly from the housing, the pair of straps wrapping around the arm support portion of the armrest to form a loop around the arm support portion; and
a connector having a pair of mating members each being coupled to a respective one of the pair of straps, each of the pair of mating members being positioned such that the pair of mating members releasably engage each other, thereby detachably coupling the heater to the arm support portion.

7. The assembly of claim 6, further comprising the connector being a hook-and-loop fastener.

8. The assembly of claim 2, further comprising the heater comprising a louver being coupled to and extending outwardly from the housing, the louver comprising:
a circumferential wall surrounding the outlet vent, the circumferential wall defining a duct being in fluid communication with the outlet vent, the circumferential wall having an opening at a distal end of the circumferential wall relative to the housing; and
a plurality of vanes being movably coupled to the circumferential wall, the plurality of vanes being positioned within the duct, each of the plurality of vanes being orientable in one of a range of angles relative to the housing.

9. The assembly of claim 2, further comprising the heater further comprising:
a control circuit being coupled to the housing, the control circuit being positioned within the interior space, the control circuit being electrically coupled to the heating element and the blower, the control circuit selectively activating each of the heating element and the blower; and
an input being coupled to the outer wall of the housing, the input being electrically coupled to the control circuit, the input being actuatable to activate each of the heating element and the blower.

10. The assembly of claim 9, further comprising the heater further comprising:
a battery being positioned within the interior space, the battery being electrically coupled to the control circuit; and
a charging port being positioned on the outer wall of the housing, the charging port being electrically coupled to the battery.

11. A personal heating assembly comprising:
a salon chair comprising:
a seat, the seat having a top surface being oriented horizontally and being configured for supporting a user on the top surface; and
an armrest being coupled to the seat, the armrest having an arm support portion being spaced above a lateral side of the seat; and
a heater being coupled to the salon chair, the heater being coupled to the arm support portion of the armrest, the heater being positioned on an underside of the arm support portion, the heater being detachable from the salon chair, the heater comprising:
a housing comprising an outer wall, the outer wall comprising a bottom member, a top member, and a perimeter member, the perimeter member extending between the bottom member and the top member, the housing having an interior space bounded by the outer wall, the housing having an outlet vent extending through the perimeter member into the interior space, the housing having an inlet vent extending through the bottom member into the interior space;
a heating element being coupled to the housing, the heating element being positioned within the interior space, the heating element selectively generating heat;
a blower being coupled to the housing, the blower being positioned within the interior space, the blower selectively urging air to flow into the interior space through the inlet vent, across the heating element, and through the outlet vent, wherein the outlet vent is positioned such that the air is directed above the seat after flowing through the outlet vent;
a pair of straps, each of said pair of straps being coupled to the housing, each of the pair of straps extending upwardly from the housing, the pair of straps wrapping around the arm support portion of the armrest to form a loop around the arm support portion;
a connector having a pair of mating members each being coupled to a respective one of the pair of straps, each of the pair of mating members being positioned such that the pair of mating members releasably engage each other, thereby detachably coupling the heater to the arm support portion, the connector being a hook-and-loop fastener;
a louver being coupled to and extending outwardly from the housing, the louver comprising:
a circumferential wall surrounding the outlet vent, the circumferential wall defining a duct being in fluid communication with the outlet vent, the circumferential wall having an opening at a distal end of the circumferential wall relative to the housing; and
a plurality of vanes being movably coupled to the circumferential wall, the plurality of vanes being positioned within the duct, each of the plurality of vanes being orientable in one of a range of angles relative to the housing;
a control circuit being coupled to the housing, the control circuit being positioned within the interior space, the control circuit being electrically coupled to the heating element and the blower, the control circuit selectively activating each of the heating element and the blower;
an input being coupled to the outer wall of the housing, the input being electrically coupled to the control circuit, the input being actuatable to activate each of the heating element and the blower;
a battery being positioned within the interior space, the battery being electrically coupled to the control circuit; and
a charging port being positioned on the outer wall of the housing, the charging port being electrically coupled to the battery.
